(19) United States
(12) Patent Application Publication
(10) Pub. No.: US 2006/0145393 A1
(43) Pub. Date: Jul. 6, 2006

(54) Manufacturing method and a molding die for a head body, made of a composite material, of a golf club

(75) Inventors: Hsiung-Ching Hsieh, Feng Shan City (TW); Chun-Yu Chang, Feng Shan City (TW); Chin-Tsun Chuang, Kaohsiung (TW)

Correspondence Address: BACON & THOMAS, PLLC, 625 SLATERS LANE, FOURTH FLOOR, ALEXANDRIA, VA, 22314, US

(73) Assignee: Advanced International Multitech Co., Ltd., Kaohsiung (TW)

(21) Appl. No.: 11/174,473

(22) Filed: Jul. 6, 2005

(30) Foreign Application Priority Data
Jan. 3, 2005 (TW) 094100052

(51) Int. Cl. B29C 70/30

(52) U.S. Cl. 264/257; 425/117

(57) ABSTRACT

A manufacturing method for a head body of a golf club made of a composite material includes steps of putting the composite material in a cavity defined in a die composed of two pieces; compacting the composite material by a core member in the cavity of the die during heating the hot die and the core member, the core member made of a thermal-dilating material and having a periphery matched with an inner contour of the head body; and separating the two pieces of the die to remove the finished head body after the composite material has hardened. Whereby, the composite material can be evenly compacted by the core piece for constructing the head body with a correct structure in accordance with the predetermined shape and having a good strength. Moreover, the core piece can be used repeatedly, so the manufacturing cost is low.

### BACKGROUND OF THE INVENTION

1. Field of the Invention

The present invention relates to a manufacturing method for a head body of a golf club, and more particularly to a manufacturing method and a molding die for a head body made of composite material.

2. Description of Related Art

In general, a head of a golf club is composed of a body and a panel secured on a front side of the body. The head body may be made of a composite material such as carbon fiber, glass fiber, etc., and the panel may be made of a metal or alloy.

With reference to FIG. 6, in a conventional manufacturing method for molding the head body, the composite material is poured in a hot die (50) which is composed of an upper semi-die (51) and a lower semi-die (52) detachably assembled together. An air bag (60) is received in a cavity defined between the upper semi-die (51) and the lower semi-die (52). During heating of the hot die (50) to harden the composite material, the air bag (60) is inflated to compact the composite material, so the finished head body (70) will be formed with a predetermined shape, as well as being hollow.

For matching some special designs such as a thick portion (A) at a rear side of the head body (70) for reinforcing its strength, composite material should be accumulated at this position. However, it is difficult for the air bag (60) to adequately compact the composite material at the thick portion (A), which is a dead angle (B) for the air bag (60), so the strength of the finished head body (70) may not be as strong as a designed requirement. Furthermore, the air bag (60) is used only one time and should be abandoned, so the manufacturing cost is high in a mass production.

Therefore, the invention provides a manufacturing method and a molding die for a head body of a golf club to mitigate or obviate the aforementioned problems.

### SUMMARY OF THE INVENTION

The main objective of the present invention is to provide a manufacturing method for a head body of a golf club which can ensure a desired quality of the finished head body with a low cost.

Another objective of the present invention is to provide a molding die using this manufacturing method.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a molding die used in manufacturing a head body of a golf club in accordance with the present invention in a detached status;

FIG. 2 is a cross sectional view of the molding die comprising two semi-dies in a combined status;

FIG. 3 is a schematic view of the semi-dies being separated for removal of the head body;

FIG. 4 is a perspective view of the head body removed from the head body;

FIG. 5 is a perspective view of the head body assembled with a strike panel; and

FIG. 6 is a sectional view of a conventional molding die for manufacturing the head body.

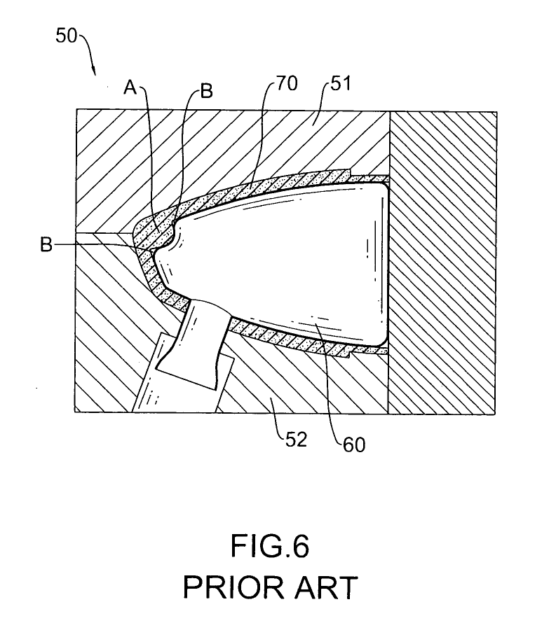

### DETAILED DESCRIPTION OF THE PREFERRED EMBODIMENT

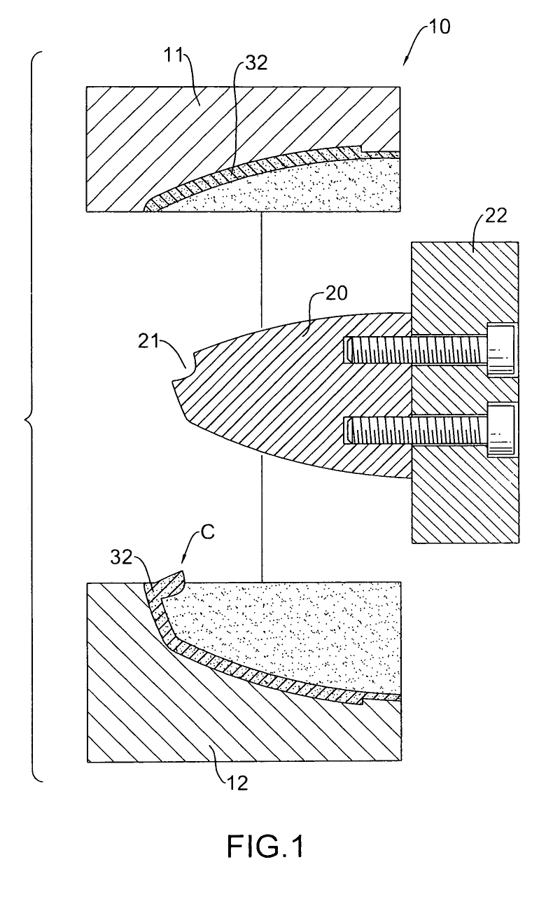

With reference to FIG. 1, the present invention is applicable for various heads of golf clubs, as an exemplary embodiment, a head with a reinforced and bob-weight portion at a rear side is described.

According to the present invention, a manufacturing method for a head body made of a composite material uses a molding die being composed of a hot die (10) and a core piece (20) received in the hot die (10) to mold the head body. The composite material is poured in the hot die (10) and compacted by the core piece (20) to form the head body into a predetermined shape. The hot die (10) is composed of an upper semi-die (11) and a lower semi-die (12) detachably assembled together.

The composite material (32) is first applied into in a cavity defined by the upper semi-die (11) and lower semi-die (12). The core piece (20) is formed of a thermal-expansive material and has an outer periphery to correspond to an interior contour of the head body. For example, a notch (21) is defined at a periphery of the core piece (20), so the composite material (32) can be accumulated in the notch (21) to form a thick portion (C) of the head body. The composite material (32) can be carbon fiber fabric, glass fiber, etc., and can be applied on an inner wall of the cavity of the hot die (10) before the core piece (20) is received in the hot die (10). Alternatively, the composite material (32) can be directly applied on the outer periphery of the core piece (20). Then the core piece (20) applied with the composite material (32) is received in the cavity of the hot die (10).

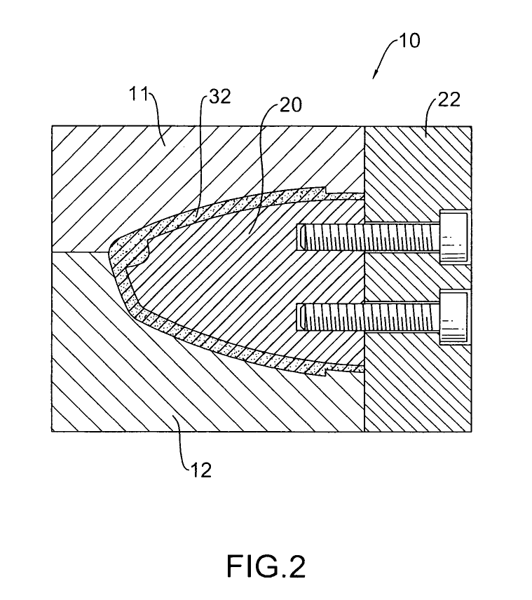

With reference to FIG. 2, the core piece (20) is received in cavity of the hot die (10) and tightly abuts the composite material (32). When the hot die (10) and the core piece (20) are heated, the core piece (20) will be expanded to compact the composite material (32) outwards, so head body is formed with the predetermined shape after the composite material (32) is hardened by means of heating.

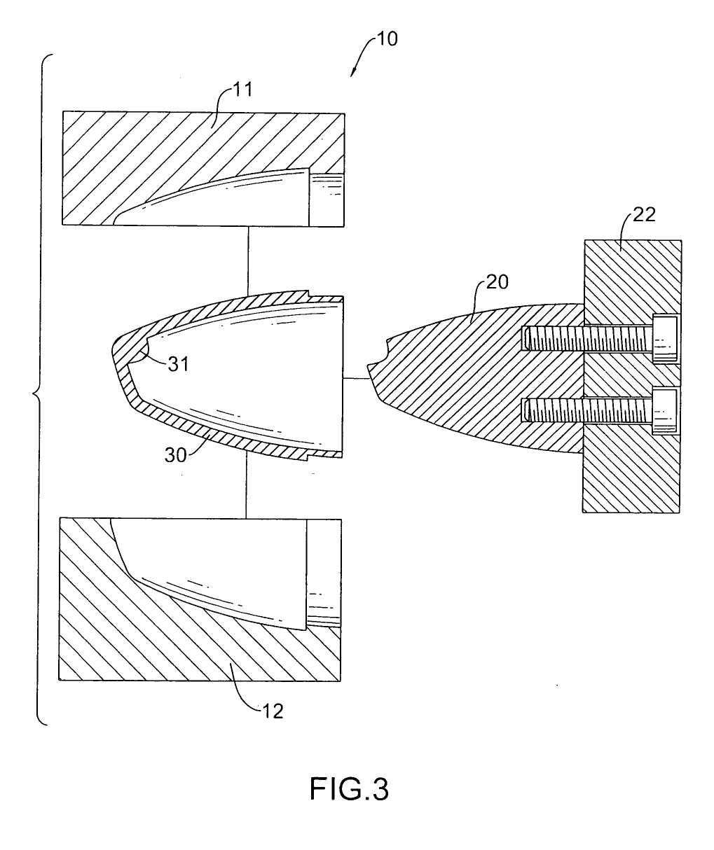

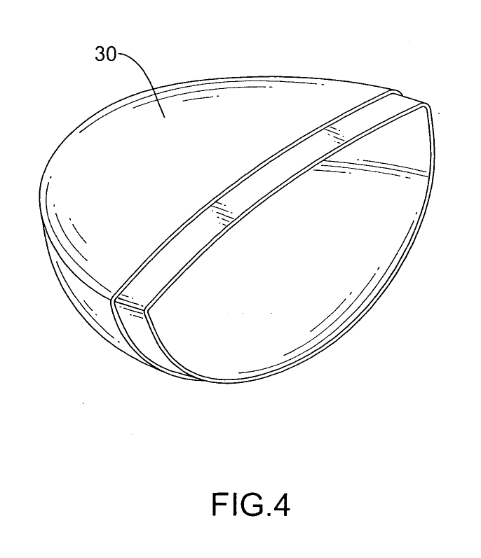

With reference to FIGS. 3-4, afterwards, the upper semi-die (11) and lower semi-die (12) are separated from each other, and the core piece (20) is removed from the hot die (10), so the head body (30) is formed with a protrusion (31) to reinforce its strength and has a center of gravity which provides a desired balance to the finished golf club.

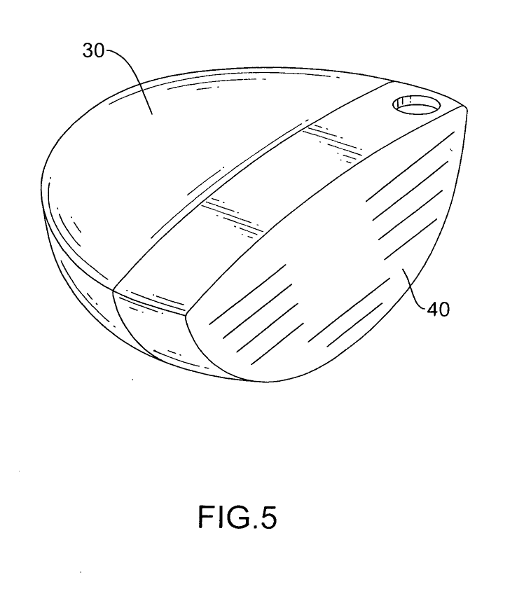

With reference to FIG. 5, the head body (30) is provided with a strike panel (40) on a front side thereof to construct an entire club head.

With reference to FIGS. 1-3, the molding die for manufacturing the head body has the hot die (10) and the core piece (20). The hot die (10) is composed of the upper semi-die (11) and the lower semi-die (12) matched with each other to define the cavity therein. The core piece (20) is mounted on a seat (22) by fasteners, and the seat (22) is mounted beside the hot die (10) to extend the core piece (20) in the cavity of the hot die (10). The core piece (20) is made of a thermal-expansive material such as silica gel and defined with the notch (21) for establishing the thick portion (C) of the head body. Therefore, the invention has advantages as follows:

1. During manufacturing, the composite material (32) is evenly compacted by the core piece (20), so the head body (30) will be formed with predetermined shape and strength.

2. The core piece (20) can be removed from the hot die (10) for being used repeatedly, so the manufacturing cost is low.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A manufacturing method for a head body of a golf club, the head body being made of a composite material, and the manufacturing method comprising acts of:
putting the composite material (32) in a cavity defined in a two-piece hot die (10), wherein the two pieces are selectively separable from each other;
compacting the composite material (32) by a core member (20) in the cavity of the hot die (10) during heating the hot die (10) and the core member (20), the core member (20) made of a thermal-expansive material and having a periphery matched with an inner contour of the head body; and
separating the two pieces of the hot die (10) to remove the finished head body after the composite material (32) is hardened.

2. The manufacturing method as claimed in claim 1, wherein the composite material (32) is applied on an inner wall of the cavity before the core member (20) is received in the cavity.

3. The manufacturing method as claimed in claim 1, wherein the composite material (32) is directly applied on the outer periphery of the core member (20) before the core member (20) is received in the cavity.

4. The manufacturing method as claimed in claim 1, wherein the composite material (32) is carbon fiber fabric.

5. The manufacturing method as claimed in claim 1, wherein the composite material (32) is glass fiber fabric.

6. A molding die for manufacturing a head body of a golf club, the head body being made of a composite material, and the molding die comprising:
a hot die (10) being composed of an upper semi-die (11) and a lower semi-die (12) selectively separable and defining a cavity in the hot die (10);
a seat (22) provided beside the hot die (10); and
a core member (20) secured on the seat (22) and received in the cavity of the hot die (10) and made of a thermal-expansive material.

7. The molding die as claimed in claim 6, wherein the core member (20) is made of silica gel.
